(19) United States
(12) Patent Application Publication
(10) Pub. No.: US 2003/0115376 A1
(43) Pub. Date: Jun. 19, 2003

(54) Method and system for the development of commerce software applications

(75) Inventors: Alexandre Drobychev, Mountainview, CA (US); James Kong, Palo Alto, CA (US); Nirupama Mallavarupu, Santa Clara, CA (US); Ching-Wen Chu, Santa Clara, CA (US)

Correspondence Address: HOGAN & HARTSON LLP, ONE TABOR CENTER, SUITE 1500, 1200 SEVENTEEN ST., DENVER, CO, 80202, US

(73) Assignee: Sun Microsystems, Inc.

(21) Appl. No.: 10/021,016

(22) Filed: Dec. 19, 2001

(51) Int. Cl. G06F 9/46; G06F 17/60; G06F 9/00

(52) U.S. Cl. 709/328; 705/1

(57) ABSTRACT

A business applications platform for providing features and services to business applications that are available across a wide variety of computing environments and operating systems. The platform includes an interface providing access to data elements, functional support for application logic, functional support for presentation logic, functional support for maintaining application data persistent within a user session, and an interface for access to business objects during a user session.

### BACKGROUND OF THE INVENTION

1. Field of the Invention

The present invention relates to a system and method for providing features and services to business applications. In particular, the present invention relates to an improved platform for providing features and services to business applications that are available across a wide variety of computing environments and operating systems.

2. Discussion of the Related Art

Over the past few years there has been an explosion of electronic commerce, known as e-commerce. E-commerce provides the ability for sellers to sell and buyers to buy virtually any product over a network, such as the Internet, with the click of a computer mouse. An increasing number of e-commerce business applications have come along with this explosion. Each business application attempts to provide a simple and secure environment for commercial transactions to take place. However, as with most competing software applications, these e-commerce applications are generally limited to use within their own narrow computing environment. Incompatibility issues generally stem from the business application platform on which the application is built. Once an application is developed it can only be used in its own environment unless it undergoes a costly conversion, known as porting.

Business application platforms used to develop and run e-commerce applications have always suffered from these disadvantages. Business application platforms are conventionally designed and developed for a specific computing environment, including for a specific operating system. For this reason a separate application platform is needed for each environment in which business applications are developed and used.

Conventional business application platforms generally provide features and services that allow a developer to create business applications that are suited only for the computing environment in which they were developed. Typically, the business applications developed rely on platform specific Application Programming Interfaces (APIs) that are not always available in other platforms.

These and other deficiencies in conventional business application platforms increase the cost and development expense of creating and running business applications in a networked computing environment. Therefore, a solution to these problems is needed, providing a business applications platform specifically designed for e-commerce business applications that allows the applications to be used across a wide range of computing environments.

### SUMMARY OF THE INVENTION

The present invention provides an application platform having a set of features and services designed to facilitate the development and use of business applications useable on any platform that supports standard Server-Side Presentation Logic.

An embodiment of the business applications platform of the present invention provides features and services for commerce software applications. The applications platform includes an interface providing access to data elements, including a data and object repository; functional support for application logic based upon inheritance from the commerce applications platform; functional support for presentation logic; functional support for maintaining application data persistent within a user session; and an interface for access to a business object during the user session.

A further embodiment of the present invention provides a method for implementing a first software application resident on a commerce application platform that provides presentation information by the first software application seeking input data from a user, receives input data from the user for use by the first software application, passes the input data to the commerce application platform for validation, validates the data by the commerce application platform, provides business object functionality to the application, and prepares presentation information by the application based upon the business object functionality.

Another embodiment of the present invention includes a method for providing services to a first software application residing on a commerce application platform that includes receiving input data from the first software application for validation, validating the input data, and providing business object functionality to the application.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a diagram of a typical networked computer system;

FIG. 2 illustrates a block diagram of an applications server in accordance with an embodiment of the present invention;

FIG. 3 illustrates a block diagram of the business applications platform and applications layer of the applications server in accordance with an embodiment of the present invention; and

FIG. 4 illustrates a flowchart for using an application based on the business applications platform in accordance with an embodiment of the present invention.

### DETAILED DESCRIPTION OF THE INVENTION

Reference will now be made in detail to various embodiments of the present invention, examples of which are illustrated in the accompanying drawings.

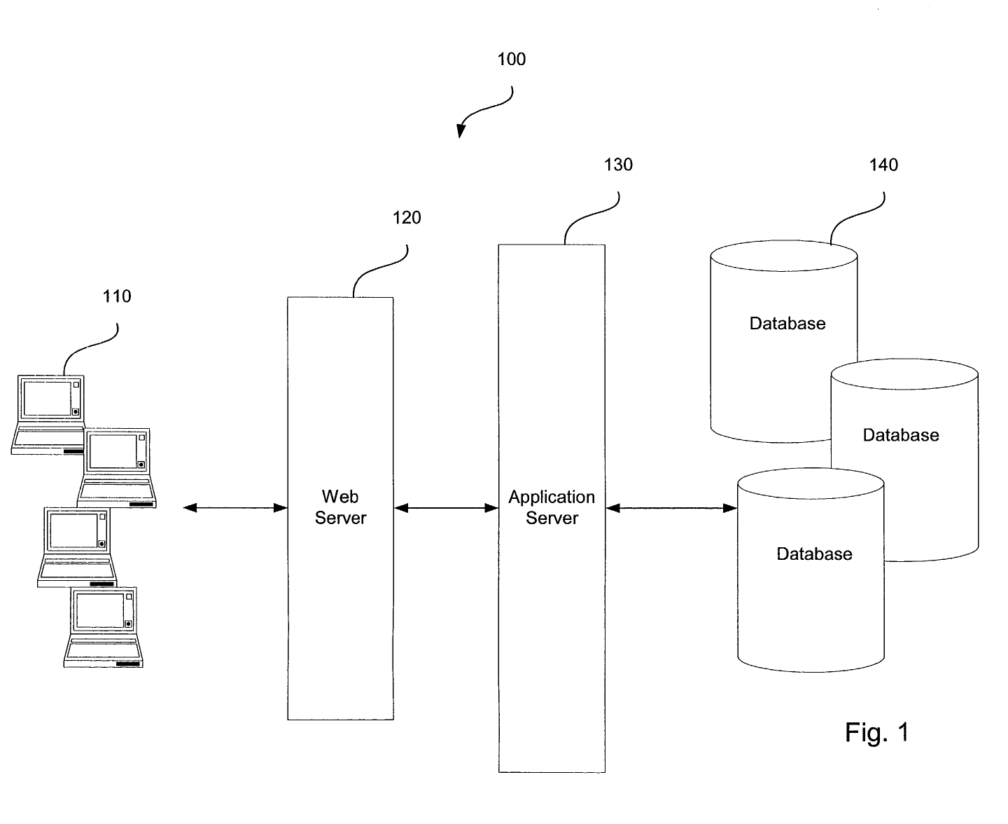

FIG. 1 shows a diagram of a typical web based system 100. Included in the system 100 are clients 110, a web server 120, an application server 130, and various storage databases 140. An individual client 110 represents a business application's end-user capable of accessing the various applications that are co-located on the application server 130 via the web server 120. The databases 140 can include typical databases, LDAP repositories, or any number of other various storage devices capable of being integrated with the application server.

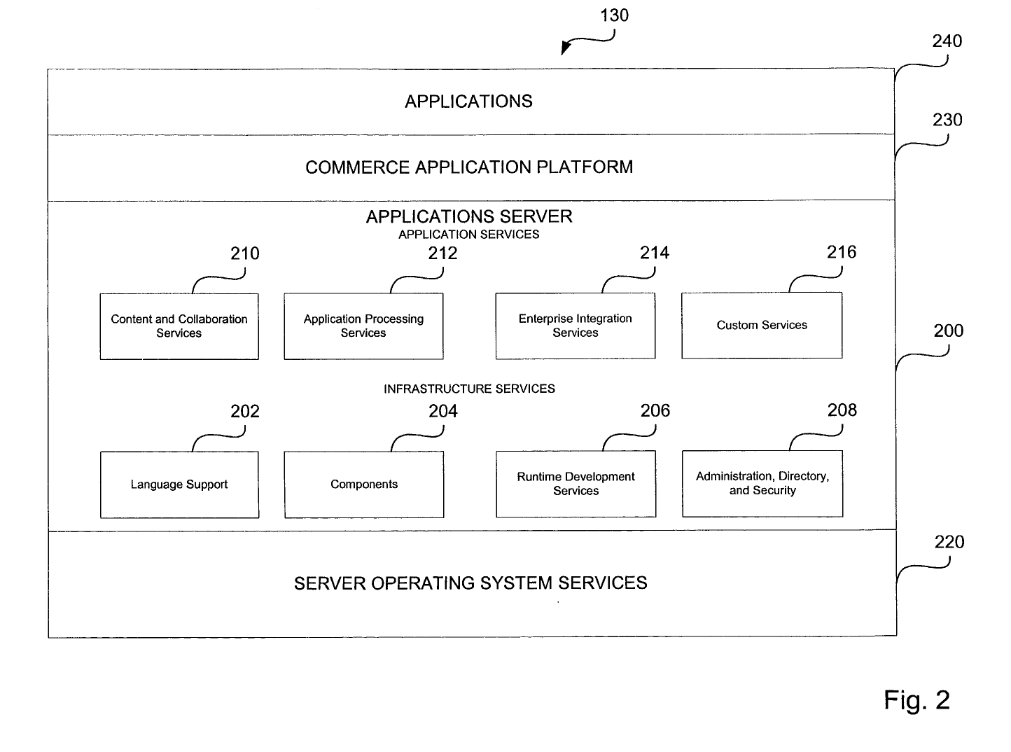

Turning to FIG. 2, the application server 130 is displayed in greater detail, including an operating system 220, an application server services 200, a commerce application platform 230, and an applications layer 240. For exemplary purposes only, the embodiments of the present invention are described as using the application server services of the Netscape Application Server (“NAS”); however, any application server supporting Server-Side Presentation Logic (“SSPL”) may be used in conjunction with the present invention.

The ability of the present invention to adapt to any application server supporting SSPL allows the application platform to be incorporated with a wide variety of application servers with minimal effort. Once the application platform is situated, any application developed for use on the platform is capable of running in the computing environment of whichever application server has been used.

The services associated with the NAS are divided into infrastructure services and application services. The infrastructure services include a language support service 202, a component architecture service 204, a runtime development service 206, and an administration, directory and security service 208. The language support service 202 provides functional support for the JAVA programming language, the JAVAscript language, as well as functional support for C and C++ programming languages. The component architecture service 204 includes components such as Enterprise JAVA beans, JAVA beans, and CORBA. The Runtime development service 206 provides request and thread management, load balancing, and failure recovery.

The application services provide support for content and collaboration services 210, application processing services 212, enterprise integration services 214, and various other custom services 216. The content and collaboration services 210 provide dynamic content, mail, streaming, searching capabilities, workflow management, and an HTTP engine. The application processing services 212 include application and transaction management, events, state and session management, scripting, user and application management, and results caching. The enterprise integration services 214 provide enterprise systems and applications, database access, ERP integration, client/server integration, and commerce exchange.

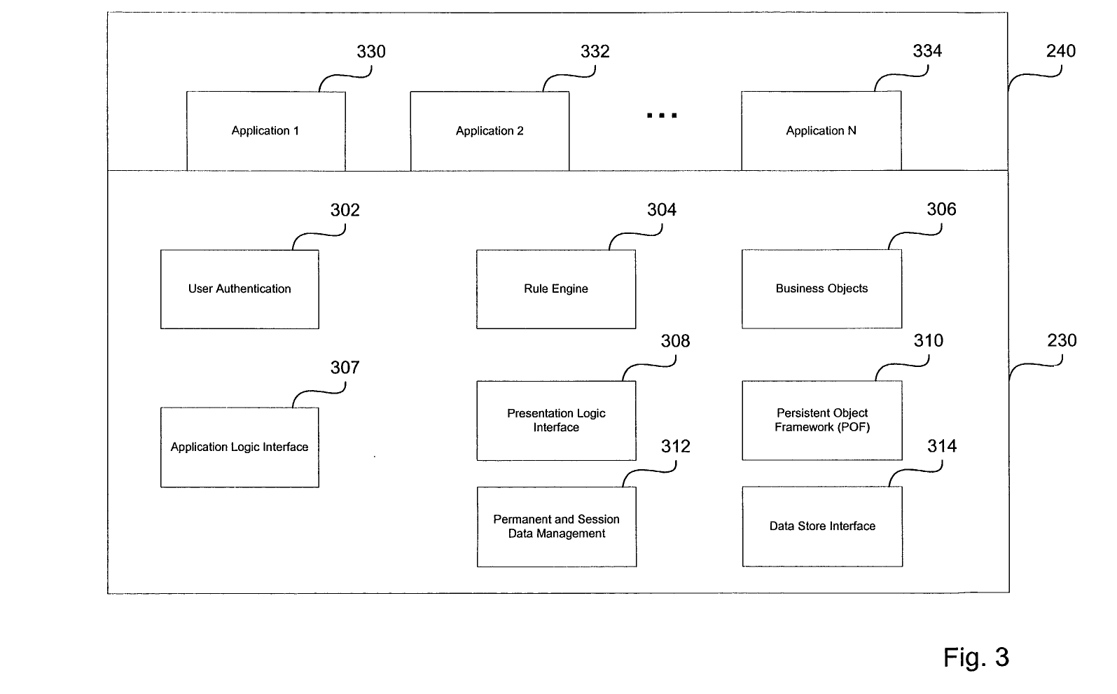

Referring to FIG. 3, the commerce application platform layer 230 and the application layer 240 are depicted in greater detail. Within the commerce application platform layer 230, various features and services are provided. These features and services include a user authentication feature 302, a rule engine 304, business objects 306, an application logic interface 307, a presentation logic interface 308, a persistent object framework 310, permanent and session data management 312 and a data store interface 314.

The data store interface 314 provides access to the data stores of the present invention. These data stores are formatted in a Name, Type, Value (“NTV”) list format. NTV is a universal data-storage format that can store any type of data. Each element includes the name, type, and value of the entry. NTV lists support embedding of NTV lists within each other, arrays of any supported type, serialization, encoding, and dot notation.

The application layer 240 illustrates various applications 330, 332, and 334. Each of the applications may run independently and concurrently on top of the application platform. Because the commerce application platform is designed to port easily to other application server platforms, the applications developed and used on the commerce application platform of the present invention will also be easily transferred to other computing environments.

Applications are a combination of Java services and engines common to all applications, top-level application code, screen templates, and configuration files. A typical programming language can be used to provide the top-level application code. In the present embodiment, Java servlets are used to provide the top-level code.

The application logic interface 307 provides applications with the ability to access platform features and services. An embodiment of the present invention uses Java servlets that inherit from the CXBase Servlet of the platform. A servlet is invoked whenever an HTML link associated with it is followed or a form associated with it is submitted. The servlet is responsible for: 1) getting data input by the end-user and validating the data; 2) performing a business function based on the data; and 3) composing the next page/frame to be presented to the end-user. During the presentation of data to a user, the servlet is responsible for placing all necessary presentation data into a Reply NTV data structure and specifying the name of an appropriate template to be used for presentation.

Servlets may contain validate and process methods. The validate method executes first to validate data input by the user. If no validation errors are detected the process method will then execute.

The presentation logic interface 308 provides applications with access to screen templates. Screen templates are created using a template language such as that associated with Java Server Pages (“JSP”). A template language provides the ability of an application to combine HTML and functional aspects to pages presented to the clients 110 (FIG. 1). Inserting tags or placeholders, such as Java scriptlets, within the HTML code creates the functional aspects of the template. Scriptlets are then used to dynamically generate data through the Java servlets.

Although many features are generally associated with JSP, it is recommended that only a subset of these features be used. That is, only the scriptlets, expressions, and declarations should be used for creating the templates of the business application platform. Additionally, this subset of features should not make use of predefined JSP beans, such as request and response.

Applications 330, 332, and 334 gain access to objects, business objects and various other data stores through the servlets via the application logic interface 307 and the JSP pages via the presentation logic interface 308. When an application is initiated, the presentation logic interface 308 of the business application platform 230 selects the template to be used and passes the necessary data to the scripting engine. The presentation logic interface 308 then starts the scripting engine, in turn evaluates the functional elements of the scripting page and streams the HTML output back to the user's browser.

Traditional methods for the presentation of data can be used within the JSP, such as conditional expressions, simple insertion of data, and array iterators. Conditionals within the scripting language use the typical “if then else” statement to implement any conditional logic.

The following discussion includes specific methods (e.g., coding examples) as may be used through the Application Logic Interface 307 and/or Presentation Logic Interface 308, where appropriate.

Simple insertion of data to the output stream by the scripting language can be generated with the following code: <%=oc.getStr (“<data element location>”)%>. The data element location is a path from the root of the reply NTV structure to the location of the data element to be displayed in place of this scriplet. The getStr method formats the data element with respect to the current locale.

Array iterators can also be used for looping over presentation data arrays. The array location should point to an array. The loop body is repeated once for each element of the array. The contents of array elements can be accessed using a getStr( ). Other useful methods include getCounter, getLimit, and getIter. GetCounter( ) returns the current zero based value of the loop counter. GetLimit( ) returns the total number of iterations. GetIter( ) is used to implement a nested loop structure.

Input controls are handled by presentation control scriptlets (“PC scriptlets”). HTML pages do not contain input controls directly. Input controls are generated from within the page templates through the use of the PC scriptlets. PC scriplets are converted into HTML user interface elements by the presentation engine. User interface elements generated this way carry some type information which is used to automatically validate the values entered by the end user. Supported control types include text, hidden field, list, radio buttons, checkbox, and submit push button.

The simplest form of a PC scriptlet is: <%=fc.getPCHtml (“<DOR entry>”, “<location>”) %>. DOR entry refers to the Data and Object Repository (“DOR”). DOR entry can either denote a simple entry or name a business object attribute. Location specifies the location within the Reply structure of the servlet generating the form where the default value for the HTML control that is generated. Location also specifies the location in the Request NTV structure of the servlet handling the submission of the form, where the input value is stored after it has been validated. Additionally, location can be a string constant or any Java expression evaluating to a string.

The DOR is an NTV structure that defines categories of data items that can be input and/or output by an application. Each category is represented by a single entry with the following format:

“DataItemName” NTV {
“datatype” Str “Int”,
“type” Str “Text”,
..... optional attributes go here .....
}

DataItemName is the name that can be referred to by a PC scriptlet. Datatype is a mandatory attribute defining the domain of valid values and the way of transforming those values from native format to external representation and vice versa. In the example above, “Int” means the domain of integer numbers, native type int and the standard conversions between integers and strings. Type is another mandatory attribute defining how to construct the HTML interface controls through which a client can enter a value of the data item. “Text” denotes the HTML input filed as a way of entering values.

In general, the roles of Type and Datatype can be described in the following manner. At page generation, datatype is used to convert the default value of a data element from its native format to external representation. Type is used to build HTML user interface elements so that their initial appearance corresponds to the external representation. At form submission, the Web browser, Web server, and NAS infrastructure guarantee that the external representation of user input is delivered to the application. Datatype is used to validate the external representation delivered and to convert it back to native format. Another responsibility of datatype is generating a descriptive error message provided the user input is not valid.

As its name reflects, the DOR may also contain business objects. A simplified business object User having two attributes Name and Password would appear as follows in the repository.

“User” NTV {
“Name” NTV {
“datatype” Str “String”,
“type” Str “Text”,
“min” Int “3”
“label” Str “user name”
},
“Password” NTV {
“datatype” Str “String”,
“type” Str “Text”,
“password” Bool “true”,
“label” Str “password”\
}
}

The user interface elements generated from a PC scriptlet includes type information that is used for field validation values input by users. In any situation where this automatic field validation is insufficient, additional validation can be implemented by overriding the validate method. Custom validation must be responsible for checking the validity of all relevant cross-field validation constraints. If all constraints are not satisfied, error messages are assigned to invalid fields and an exception is thrown. This process regenerates the current page to the user with invalid fields marked and accompanied with error messages.

Error handling within the business application platform is processed using the Java throw-catch exception methodology. The applications platform of the present invention also provides for the localization of error messages, as well as flexible mechanisms of error reporting. Methods should throw an exception only if it detects an exceptional situation that prevents is from completing its job.

Permanent and session data management 312 is also provided within the business application platform 230 of the present invention. Permanent and session application data is persistent across user request boundaries. Both types can be characterized by the same life span and isolation level—a single user session. Permanent data resides in an NTV tree that is accessible by getPermData( ). Data placed in this NTV tree survives termination of the current servlet and is available in subsequent servlets of the same user session. Permanent data is managed by sending it back and forth between the client and server by using hidden fields and URL parameters. The size of the permanent data NTV tree is limited to approximately 2-3K. The size is limited because this data is appended to every link as an additional URL parameter and every form as an additional hidden field on the user's page. With limited size, and attachment to every link, it is important to remove data that is no longer needed.

When using permanent data, to associate a link with a servlet the following format is used: HREF=“<%=oc.getSrevletURL (“<Servlet>”, <Parameters>) %>”. Parameters is an NTV structure containing parameters to be passed to the servlet. The contents of this NTV structure will be merged into the servlet's Request NTV. To create a link pointing to a URL the following format is used: HREF=“<%=oc.getURL (“<URL>”) %>”.

Session data stores individual data items in a hashtable whose keys are strings. Four session data methods are used to manage the session data items. GetSessionObj(strKey) returns data items stored in the session data object with a given key. SetSessionObj(strKey, value) stores a value in session data. RemSessionObj(strKey) removes an item from session data. GetSession( ) returns the entire hashtable.

Both permanent and session data have size limitations and are therefore not suited for storing large dynamic objects. The applications platform provides access to a stateful session bean for large objects. One such bean is created per user session. It serves as a container for all large dynamic objects. To access these objects a servlet must implement the EXEC_MODEL_STATEFUL execution model, allowing its process method to run co-located with the stateful bean, and with the objects stored within the stateful bean.

There are three execution models implemented by the applications platform: EXEC_MODEL_LOCAL, EXEC_MODEL_STATELESS, and EXEC_MODEL_STATEFUL. When running under the local execution model, both validate and process methods are executed in the same Java Virtual Machine (“JVM”). This is the most efficient execution model; however, it does not support stateful session objects and transaction management. When using the stateless execution model, the process method is executed in the context of a stateless Enterprise Java Bean (“EJB”). Distributed transaction support is available, making possible access to different transactional datastores and/or calling third party EJBs in a single atomic transaction. When using the stateful execution model, the process method is executed in the context of the stateful EJB serving as a container for all session-persistent objects. Such objects can be easily accessible, as the process method and the object reside in the same JVM. Distributed transactions are also available in the stateful mode.

User authentication 302 is also provided by the application platform, but it is allowed to be manipulated by a servlet. User authentication is done once per session, usually when a user logs-in. Verification of user authentication is generally stored in an application server session layer. Servlets, by default, are secure, meaning they will not perform any function unless the end-user is authenticated. It is necessary that some servlets are made unsecure. For example, the servlet that displays the login screen, as well as any other servlet that functions prior to user login, must be unsecure. Such servlets are provided with the ability to override the security requirement.

Cross-application links, the ability to connect to screens belonging to different applications, are supported through user authentication 302. This allows an authenticated user to move among applications without going through additional login screens for each application.

Business objects 306 and Persistent Object Framework (“POF”) support 310 provide management of objects and business objects for use by the application logic interface 307. Through POF, persistent objects, including persistent business objects, can be created and used with the various business applications.

Business objects 306 may be POF-based business objects or Non POF-based business objects. POF-based business objects are POF objects with additional data and behavior. POF-based business objects inherit from the CXBaseBO that in turn inherits from CXPObject; therefore, all business objects are effectively persistent objects and all POF services are available for business objects.

All POF-based business objects must be represented in the DOR. Each DOR entry for a business object should include two attributes, a POF factory name and a fully qualified name of the Java class for the object. The POF factory name is the factory name for the persistent part of the object, for example SXUser. The fully qualified name is the name of the Java class derived from CXBaseBO, for example, UserBO. Including these two attributes in the DOR ensures that it is known that a given CXPObject is actually SXUser, and the object can be safely cast to UserBO allowing public members of UserBO to be accessed and public business methods to be invoked. Additionally, the object identity feature of POF will take place on the business object level, allowing any two UserBO references of the same datastore entity to actually point to the same Java object.

Various helper methods are also included for all business objects 306. These methods are setAttributes, getAttributes, save, and remove. SetAttributes(NMV) sets multiple attributes of the business object. This method goes over the NTV for each data item in the NTV. Any identically named attributes in the object are assigned the value of this data item of the NTV. If the NTV contains nested NTVs, data items of these nested NTVs are assigned to attributes of corresponding objects. GetAttributes returns the names and values of all attributes of the object. The method returns an NTV containing one entry for each attribute. Save( ) stores the persistent part of the object in the proper datastore. Remove( ) removes the object from the persistent datastore.

Non-POF business objects inherit from CXBaseNPBO. CXBaseNPBO views a business object as a collection of attributes, each having a name and a value. Non-POF business objects are generally not required to have a description in the DOR; however, it is likely that several attributes of an object will require exposure to the presentation logic interface 308 and/or need to be imported or exported. In these instances it is useful to have the non-POF business object attributes listed in the DOR. POF_factory and java_class are not used by a non-POF business object.

Business objects and non-business POF objects can be cached with the stateful EJB. By caching the objects they are easily accessible by any subsequent servlets running in the stateful execution mode of the same session. An object can be placed into cache by calling setEJBStatePO(“<name>”, <handle>) where name is the name under which the object is stored in the cache and handle is the object's handle. This method is defined in CXBaseLogic. A cached object can be retrieved by using getEJBStatePO(“<name>”, <handle>). Handle must be specified to allow the platform to load the object from a persistent datastore if the cache has been cleared. Thus, the handle must be made available for other servlets of the same session. A handle is typically made available by storing it in session or permanent data. For example, if an application stores its current order in the stateful EJB cache, it must store the current order object in the EJB and store the handle of the order object in permanent or session data.

The rule engine 304 of the business application platform 230 evaluates attributes associated with a user or a specific transaction. To evaluate a rule, a rule engine 304 is instantiated and an instance of an attribute server is required. Attribute server objects encapsulate a database connection. To store this connection the attribute server object is created and cached by the platform. In contrast, the rule engine objects are lightweight and may be created on an as-needed basis.

To evaluate a rule, the name of the rule and the set of its roles must be specified. Roles act like formal parameters of a rule. Roles should be created before evaluating the rule context object. A new context can be created for each rule evaluation. Alternatively, the framework supports a global rule context whose lifetime is a single user request. The role value put into a global rule context remains there until it is explicitly removed or until the current request is completely processed. The business objects and the business services layers evaluate the rules, not the servlet layer.

Localization of an application is also handled by the business object platform. The platform must select configuration information corresponding to the current locale. When an application specifies a template, it must specify the template name only. The business applications platform selects the correct localized version of the template.

An end-user will specify his/her desired locale during login. This information will be stored in the application server session layer. In the case of cross-application links, information about the current locale is passed between applications as a set of request parameters.

Global data whose life span is a single user request creates an additional problem that is solved by the business application platform of the present invention. This type of data cannot be stored in static variable of a servlet because it is possible to have multiple instances of the same servlet running in parallel. Storing the data in a servlet's member variables is also deficient, as it creates the problem of needing to determine the current instance of a servlet. Additionally, in execution models other than EXEC_MODEL_LOCAL, i.e. stateless and stateful, locating the current servlet may not be possible because the process method can run in a different JVM.

The business applications platform provides CXRequestContext class as a solution to the problem. SetRequestObj of the class is used to store any global data of a single user request. GetRequestObj of the class is used to access the previously stored data. Any Java object can be stored in this manner.

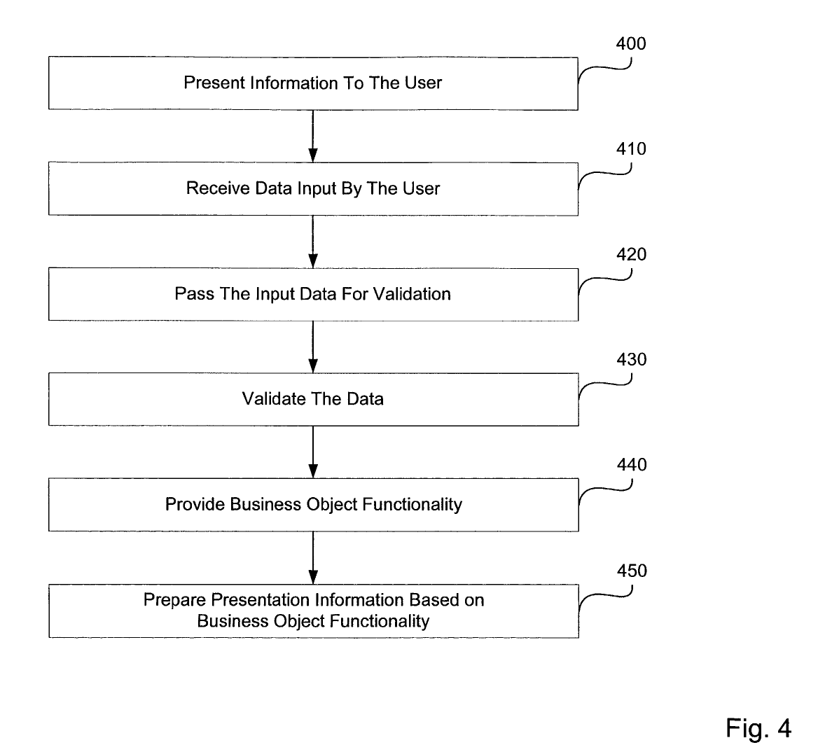

FIG. 4 shows process for implementing a software application resident on the commerce application platform of the present invention. In accordance with one embodiment of the invention, the process begins in step 400 where information is presented to the user. The information presented may be static, dynamic, or any other type of information capable of presentation by the programming language used within the present invention.

In accordance with an embodiment of the invention, the process includes step 410 where data input by the user for use by the software application is received. Step 420 passes the input data to the commerce application platform of the present invention for validation. It should be understood that user identification information and data corresponding to specific commerce functionality may be included among the wide range of possible data input by the user and passed for validation.

The process continues in step 430 where the received data is validated by the commerce application platform. Validation ensures that appropriate security measures and other actions can be taken with the data. A rule engine may be invoked to determine validation results, including such things as appropriate user access, business function, or user discounts (not shown in FIG. 4).

According to an implementation of the present invention, validated data is used to determine business object functionality in step 440. Business objects may be created to handle the needed functionality, or an already existing business object may be accessed to perform the necessary process. Data stores, including permanent or session data, may also be accessed through the business objects to provide information needed to perform the current business object functionality.

In step 450, presentation information is generated based upon the business object functions performed in step 440. Presentation information may once again be provided to the user, or the process may be terminated.

It will be apparent to those skilled in the art that various modifications and variations can be made in the implementation of the present invention without departing from the spirit or scope of the invention. Thus, it is intended that the present invention covers the modifications and variations of this invention provided that they come within the scope of any claims and their equivalents.

What is claimed is:

1. A commerce applications platform for providing features and services for commerce software applications, and operatively adaptable to a server platform capable of server-side presentation logic, the commerce applications platform comprising:
an interface providing access to data elements, including a data and object repository;
functional support for application logic based upon inheritance from the commerce applications platform;
functional support for presentation logic;
functional support for maintaining application data persistent within a user session; and
an interface for access to a business object during the user session.

2. The commerce applications platform of claim 1, wherein the data elements are stored within a computer-readable medium in the form of a data structure forming a list of at least one data element, wherein each data element comprises:
a first field containing data representing a data element name;
a second field containing data representing the data element type; and
a third field containing data representing the data element value.

3. The commerce applications platform of claim 1, further comprising a rule engine for evaluating rule parameters.

4. The commerce applications platform of claim 1, further comprising a data management interface for the storage and retrieval of data during a user session.

5. The commerce applications platform of claim 1, further comprising user authentication logic that provides or denies a user access to the commerce software applications.

6. The commerce applications platform of claim 1, further comprising a data store interface used to transfer data to and from a data store.

7. The commerce applications platform of claim 6, wherein the data store further comprises LDAP data stores.

8. The commerce applications platform of claim 6, wherein the data store further comprises database data stores.

9. The commerce applications platform of claim 1, wherein the business object is cached during the user session.

10. A method for implementing a first software application resident on a commerce application platform, comprising:
providing presentation information by the first software application seeking input data from a user;
receiving input data from the user for use by the first software application;
passing the input data to the commerce application platform for validation;
validating the data by the commerce application platform;
providing, by the commerce application platform, business object functionality to the application; and
preparing presentation information by the application based upon the business object functionality.

11. The method of claim 10, wherein the step of providing presentation information further comprises providing static and dynamic presentation data.

12. The method claim 10, wherein the passing of input data further comprises passing user identification information.

13. The method of claim 10, wherein the passing of input data further comprises passing data corresponding to commerce functionality.

14. The method of claim 10, wherein the step of validating the data further comprises invoking a rule engine to determine a validation result.

15. The method of claim 10, further comprising the step of creating, by the commerce application platform, a business object for providing business functionality.

16. The method of claim 10, further comprising the step of accessing, by the commerce application platform, an existing business object.

17. The method of claim 10, further comprising the step of accessing permanent or session data.

18. The method of claim 10, further comprising the step of implementing a second software application on the commerce application platform.

19. The method of claim 18, further comprising the step of implementing a second software application by concurrently implementing the first software application and the second software application.

20. The method of claim 18, further comprising the step of accessing a business object by both the first and the second software applications.

21. A method for providing services to a first software application residing on a commerce application platform, comprising:
receiving from the application input data for validation;
validating the input data; and
providing business object functionality to the application.

22. The method of claim 21, wherein the input data received from the application relates to a commerce application function.

23. The method of claim 21, wherein the input data received from the application includes user identification information.

24. The method of claim 21, wherein the step of validating the input data further comprises invoking a rule engine to determine a validation result.

25. The method of claim 21, further comprising the step of creating a new business object.

27. The method of claim 21, further comprising the step of accessing an existing business object.

28. The method of claim 21, further comprising the step of accessing permanent data.

29. The method of claim 21, further comprising the step of accessing session data.

30. The method of claim 21, further comprising the step of creating a persistent object based on a persistent object framework.

31. The method of claim 21, further comprising the step of receiving input data from a second application on the commerce application platform

32. The method of claim 21, wherein the step of receiving input data from the first software application further comprises concurrently receiving input data from a second software application

33. The method of claim 21, wherein the step of providing business object functionality to the application further comprises providing the same business object functionality to a second software application.
